(19) United States
(12) Patent Application Publication
(10) Pub. No.: US 2003/0061511 A1
(43) Pub. Date: Mar. 27, 2003

(54) Secure communication of information via a communication network

(76) Inventor: Todd Fischer, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/965,164

(22) Filed: Sep. 27, 2001

(51) Int. Cl. H04L 9/00

(52) U.S. Cl. 713/201; 713/150

(57) ABSTRACT

Methods for securely communicating information are provided. A representative method includes: communicating an address to a first network device via the Internet; receiving encrypted information from the first network device via the Internet; enabling the encrypted information to be posted at the address; and enabling a second network device to access and retrieve the encrypted information from the address via the Internet while the encrypted information is posted. Systems and other methods also are provided.

### FIELD OF THE INVENTION

The present invention generally relates to communications. More specifically, the invention relates to communicating information securely from one network device to another.

### DESCRIPTION OF THE RELATED ART

Various techniques are known for communicating information from one network device to another. By way of example, when a user intends to communicate information from a device associated with a network that includes a firewall to another device, which is associated with a separate network incorporating its own firewall, one of three techniques typically is employed. In particular, email, a virtual private network and explicit firewall reconfiguration can be used.

Since, in the scenario mentioned above, each network device is protected by a corresponding firewall, using email permits information to be provided from one of the devices to the other while traversing the firewalls. However, since email protocol, such as Simple Mail Transfer Protocol (SMTP), is a store-and-forward protocol, information being transferred via email can experience significant delays.

The use of virtual private networks also can be problematic. More specifically, the configuration effort associated with establishing virtual private networks oftentimes renders their use impractical. Since establishing a virtual private network typically is labor intensive, the use of such a network on less than a continuous basis is rarely justifiable.

One or more firewalls associated with the network devices also can be reconfigured to permit an exchange of information between the devices. However, as a practical limitation, firewall configuration changes rarely are considered. This is because firewall reconfiguration may adversely affect the security of the corresponding network. Even more problematic is the fact that effects on the security of the network may be difficult to predict.

Based on the foregoing, it should be appreciated that there is a need for improved systems and methods that address the aforementioned and/or other shortcomings of the prior art.

### SUMMARY OF THE INVENTION

Briefly described, the present invention relates to the secure communication of information. In this regard, embodiments of the invention may be construed as methods for securely communicating information. A representative embodiment of such a method includes: communicating an address to a first network device via the Internet; receiving encrypted information from the first network device via the Internet; enabling the encrypted information to be posted at the address; and enabling a second network device to access and retrieve the encrypted information from the address via the Internet.

Another embodiment of such a method includes: providing a first network device; receiving, at the first network device, address information via the Internet; providing a decryption key and the address to a mobile appliance via a secure communication link; and providing encrypted information to the address via the Internet. In this manner, a second network device is enabled to retrieve the encrypted information from the address via the Internet and decrypt the information using the decryption key provided from the mobile appliance.

Embodiments of the invention also may be construed as systems for enabling secure communication of information between a first network device and a second network device via the Internet. In this regard, a representative embodiment of such a system includes a secure tunnel system that communicates with the Internet. The secure tunnel system is configured to provide address information to a first network device via the Internet. The secure tunnel system is further configured to receive encrypted information from the first network device via the Internet, which the secure tunnel system then posts at an address associated with the address information. The secure tunnel system also enables a second network device to access and retrieve the encrypted information from the address via the Internet.

Another embodiment of such a system includes an information request system that is configured to communicate with first and second network devices. The information request system is configured to receive an input from a user that corresponds to the user's intent to have encrypted information communicated to the second network device. The information request system is further configured to receive a decryption key and information corresponding to an address from the first network device. Typically, the encryption key and the information corresponding to the address is communicated in a secure format. The information request system provides the decryption key and the information corresponding to the address to the second network device. This also typically is done in the secure format. So configured, the information request system enables the second network device to retrieve encrypted information posted on the Internet at the address and decrypt the information using the decryption key.

Other features of the present invention will become apparent to one with skill in the art upon examination of the following drawings and detailed description. It is intended that all such features be included herein within the scope of the present invention, as defined in the appended claims.

### BRIEF DESCRIPTION OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting a representative embodiment of a secure communication system of the present invention.

FIG. 2 is a flowchart depicting representative functionality of the embodiment of the secure communication system of FIG. 1.

FIG. 3 is a schematic diagram of a representative computer or processor-based system that can be used to implement at least a portion of the secure communication system of FIG. 1.

FIG. 4 is a flowchart depicting representative functionality of the embodiment of the secure tunnel system depicted in FIG. 3.

FIG. 5 is a schematic diagram depicting another embodiment of the secure communication system of the present invention.

FIG. 6 is a flowchart depicting representative functionality of the embodiment of the tunnel initiation system of FIG. 5.

FIG. 7 is a flowchart depicting representative functionality of the embodiment of the tunnel completion system depicted in FIG. 5.

FIG. 8 is a flowchart depicting another embodiment of the secure communication system of the present invention.

FIG. 9 is a flowchart depicting representative functionality of an information request system of the present invention.

### DETAILED DESCRIPTION

Systems and methods of the present invention can be used to securely communicate information from a network device of one network to a network device of another network. Typically, such a network, e.g., a local area network (LAN), provides a firewall between its network device and the Internet. As used herein, “firewall” refers to a security system that is configured to prevent a device associated with one network from communicating directly with a device(s) external to that network and vice versa. As will be described in greater detail herein, information preferably is communicated via standard network protocols, such as Hypertext Transfer Protocol (HTTP), and can be used without requiring one or more of the firewalls to be reconfigured.

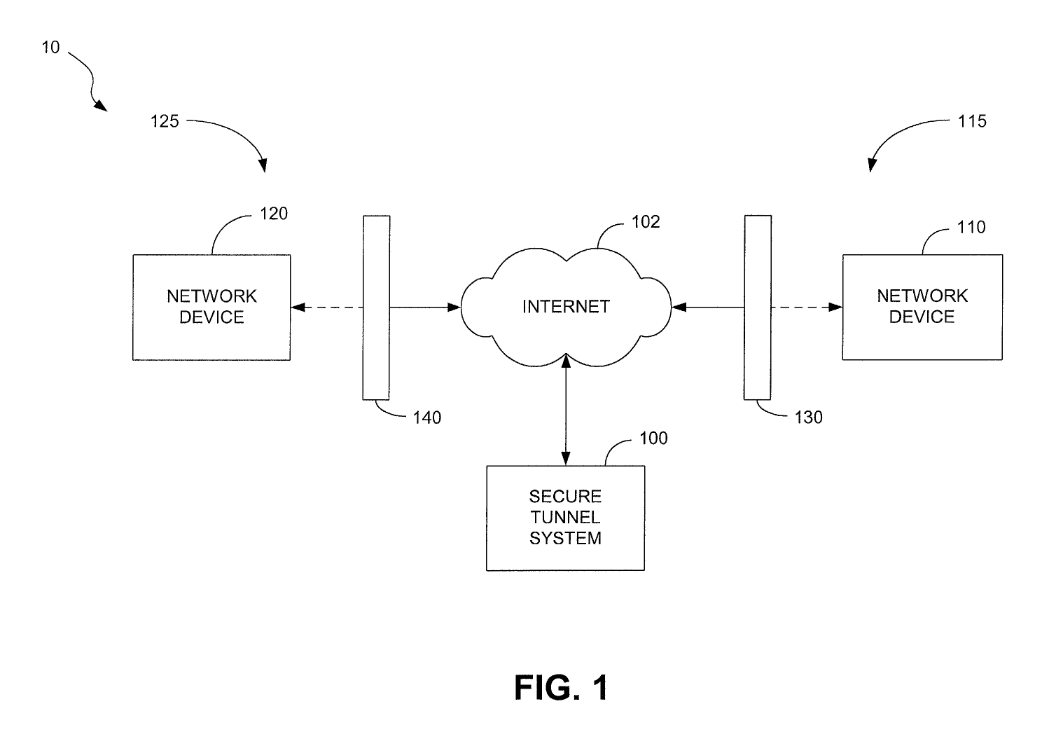

Referring now to the drawings, wherein like reference numerals indicate corresponding components throughout the several views, FIG. 1 is a schematic diagram depicting an embodiment of the secure communication system 10 of the present invention. As shown in FIG. 1, secure communication system 10 includes a secure tunnel system 100 that is configured to communicate with the Internet 102. The secure tunnel system 100 is used to facilitate the transfer of information from one network device to another. By way of example, a first network device 110 and a second network device 120 are depicted in FIG. 1. Each of these devices is configured to communicate with the Internet via their respective networks 115 and 125. Note, network 115 includes a firewall 130, and network 125 includes a firewall 140.

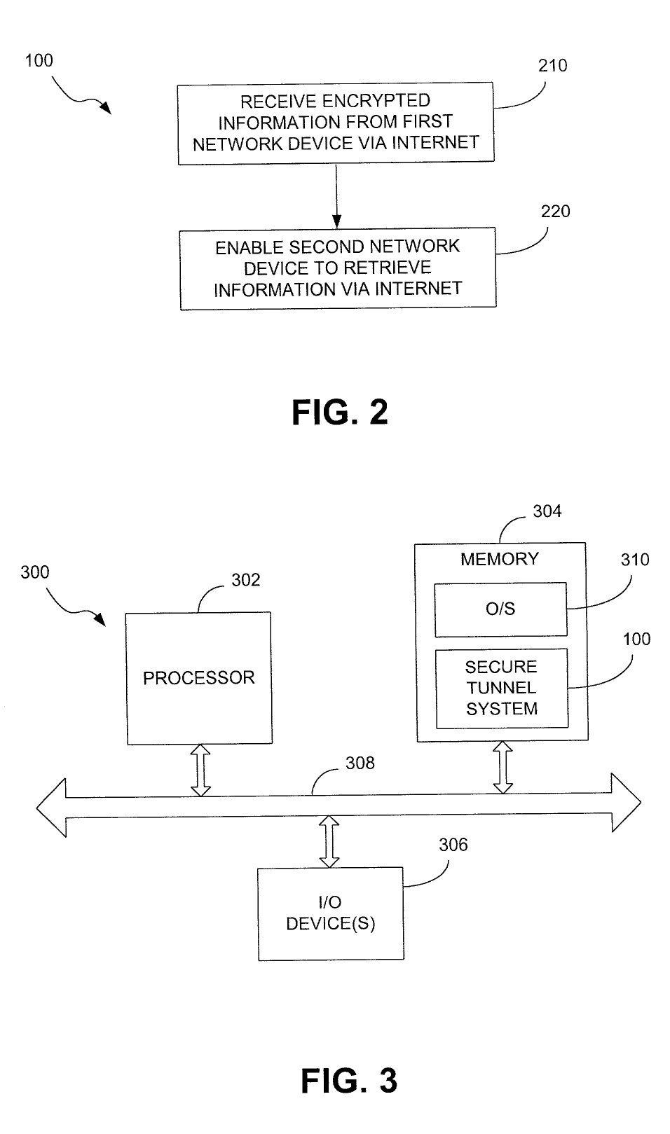

FIG. 2 is a flowchart depicting functionality of an embodiment of the secure tunnel service 100. As shown in FIG. 2, the functionality preferably includes receiving information from a first network device via the Internet (block 210), and then enabling a second network device to retrieve the information via the Internet (block 220). Preferably, the information provided by the first network device is in a secure format, e.g., encrypted, and remains in a secure format until after being received by the second network device. In some embodiments, once the second network device has retrieved the information, the secure tunnel system can prevent the information from being retrieved again. By way of example, the secure tunnel system can limit access to the information by placing a time limit on its availability for retrieval and/or enabling the information only to be accessed once, such as by using a URL incorporating a Globally Unique Identifier (GUID). Such a URL may be referred to herein as a “one-time URL.”

Secure tunnel system 100 can be implemented in software, firmware, hardware, or a combination thereof. When implemented in software, secure tunnel system 100 can be a program that is executable by a digital computer, an example of which is depicted schematically in FIG. 3.

Generally, in terms of hardware architecture, computer 300 of FIG. 3 includes a processor 302, memory 304, and one or more input and/or output (I/O) devices 306 (or peripherals) that are communicatively coupled via a local interface 308. Local interface 308 can be, for example, one or more buses or other wired or wireless connections, as is known in the art. Local interface 308 can include additional elements, which are omitted for ease of description. These additional elements can be controllers, buffers (caches), drivers, repeaters, and/or receivers, for example. Further, the local interface may include address, control, and/or data connections to enable appropriate communications among the components of computer 300.

Processor 302 can be a hardware device configured to execute software that can be stored in memory 304. Processor 302 can be any custom made or commercially available processor, a central processing unit (CPU) or an auxiliary processor among several processors. Additionally, the processor can be a semiconductor-based microprocessor (in the form of a microchip), for example.

Memory 304 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 304 can incorporate electronic, magnetic, optical, and/or other types of storage media. Note that memory 304 can have a distributed architecture, where various components are situated remote from one another, but can be accessed by processor 302.

The software in memory 304 can include one or more separate programs, each of which comprises an ordered listing of executable instructions for implementing logical functions. The software in the memory 304 includes secure tunnel system 100 and a suitable operating system (O/S) 310. The operating system 310 controls the execution of other computer programs, such as secure tunnel system 100. Operating system 310 also can provide scheduling, input-output control, file and data management, memory management, and communication control and related services.

The I/O device(s) 306 can include input devices, such as a keypad and/or a receiver, for example. I/O device(s) 206 also can include output devices, such as a display device and/or a transmitter, for example. I/O device(s) 206 may further include devices that are configured to communicate both inputs and outputs, such as a network communication port, for example.

When the computer 300 is in operation, processor 302 is configured to execute software stored within the memory 304, communicate data to and from the memory 304, and generally control operations of the computer 300. Secure tunnel system 100 and the O/S 310, in whole or in part, are read by the processor 302, perhaps buffered within processor 302, and then executed.

When secure tunnel system 100 is implemented in software, it should be noted that the remote print system can be stored on any computer readable medium for use by or in connection with any computer-related system or method. In the context of this document, a computer-readable medium is an electronic, magnetic, optical, or other physical device or means that can contain or store a computer program for use by or in connection with a computer-related system or method. Secure tunnel system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

When implemented in hardware, secure tunnel system 100 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

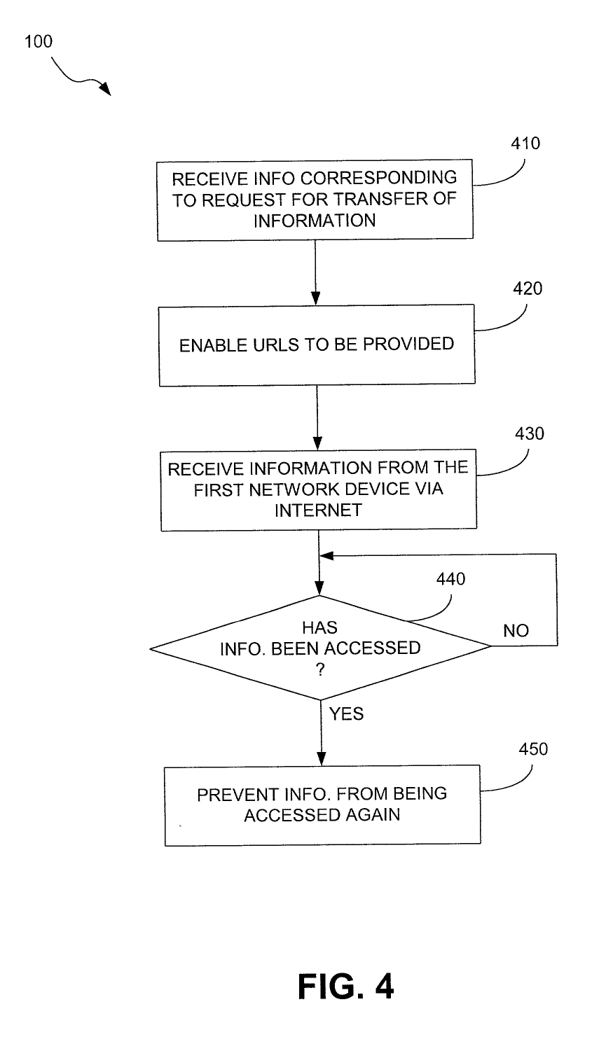

Reference will now be made to the flowchart of FIG. 4, which depicts the functionality of a representative embodiment of secure tunnel system 100. In this regard, each block of the flowchart represents a module segment or portion of code that comprises one or more executable instructions, or logic for implementing the specified logical function(s). It should also be noted that in some alternative implementations the functions noted in various blocks of FIG. 4, or any other of the accompanying flowcharts, may occur out of the order in which they are depicted. For example, two blocks shown in succession in FIG. 4 may, in fact, be executed substantially concurrently. In other embodiments, the blocks may sometimes be executed in the reverse order depending upon the functionality involved.

As shown in the flowchart of FIG. 4, the secure tunnel system or method 100 may be construed as beginning at block 410, where information corresponding to a request for secure tunnel services is received. In block 420, two one-time URLs that can be used to establish a secure tunnel are provided. For instance, one of the URLs can be used by a first network device, i.e., the network device that provides the information that is to be communicated, and the other of the URLs can be used by the second network device, i.e., the device that is the intended recipient of the information. Preferably, the URLs are provided to the first network device via the Internet using a secure connection, such as a connection facilitated by HTTPS. Since the information is provided via the Internet, a firewall associated with the first network device should allow the information to pass to the first network device when a Hypertext Transfer Protocol, such as HTTPS, is used.

In block 430, encrypted information from the first network device is received via the Internet. This information is posted at the first URL. Thereafter, such as depicted in block 440, a determination may be made as to whether the information posted at the first URL has been accessed by the second network device, i.e., accessed by using the second URL. If it is determined that the information has been accessed, the process may proceed to block 450, where further access to the information can be disabled.

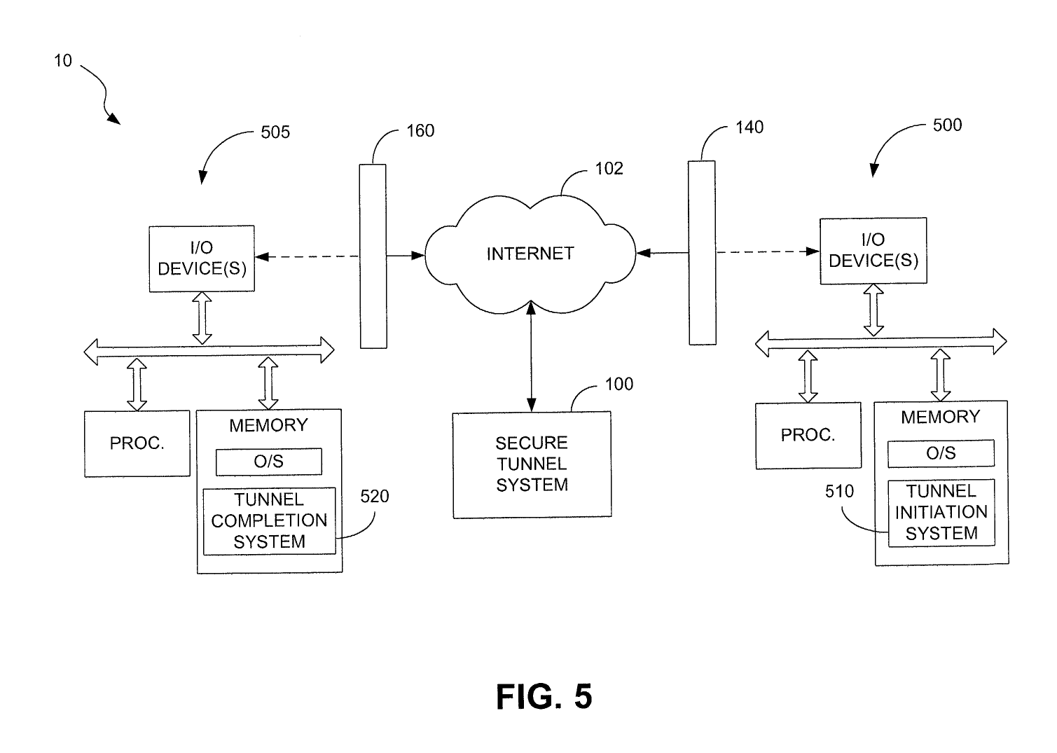

It should be noted that in the flowchart of FIG. 4, the secure tunnel system 100 is described as receiving encrypted information. As is known, encryption of information typically is enabled by using an encryption key. Similarly, encrypted information typically is decrypted using a corresponding decryption key. In some embodiments, the encryption and decryption keys can be provided by the secure tunnel system. In other embodiments, however, a system associated with one of the network devices and/or a mobile appliance (described later) can provide the encryption and decryption keys. An example of a system that can provide encryption/decryption keys is a tunnel initiation system, a representative embodiment of which is depicted in the schematic diagram of FIG. 5.

As shown in FIG. 5, an embodiment of the secure communication system 10 uses a tunnel initiation system 510, in association with the first network device, and a tunnel completion system 520, in association with the second network device. In FIG. 5, each of the network devices (500, 505) is implemented with a computer or processor-based system, much like the computer 300 described before in relation to FIG. 3. These systems will not be described in detail here, as the architecture and operation of these systems should be readily apparent to one of ordinary skill in the art. Additionally, each of these systems could be implemented in software, firmware, hardware, or a combination thereof.

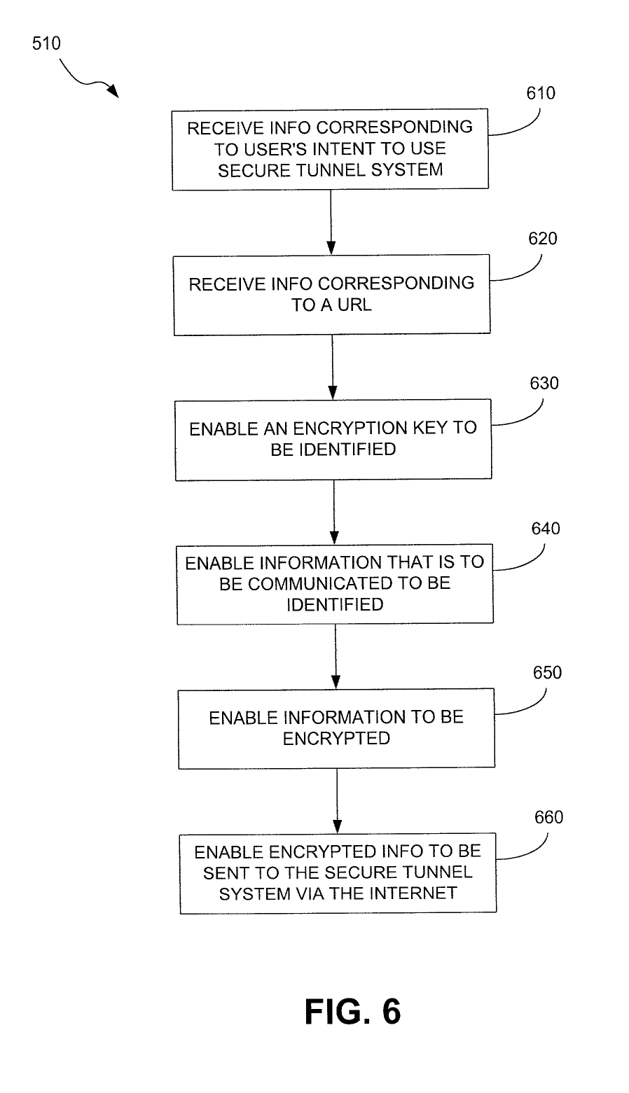

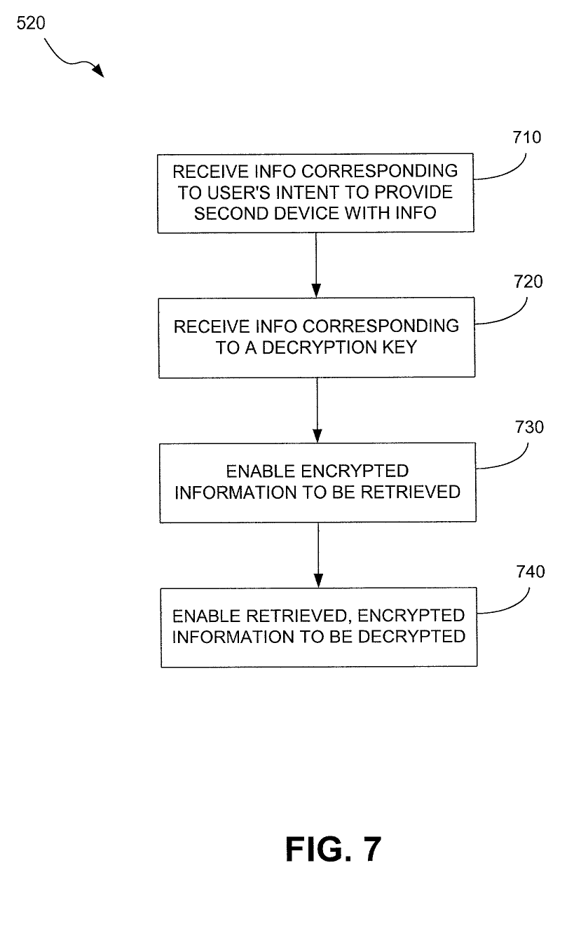

Functionality of representative embodiments of the tunnel initiation system 510 and tunnel completion system 520 will now be described with reference to the flowcharts of FIGS. 6 and 7, respectively. As shown in FIG. 6, the tunnel initiation system or method 510 may be construed as beginning at block 610, where information corresponding to a user's intent to use a secure tunnel is received. In block 620, at least a first one-time URL is received. As described before, such a one-time URL can be used by the first network device to provide information to the secure tunnel system via the Internet. In block 630, an encryption key is identified. This encryption key is used to encrypt the information that is to be communicated to the secure tunnel system. In some embodiments, the tunnel initiation system can generate the encryption key as well as a corresponding decryption key. In such an embodiment, the tunnel initiation system or method would include the step of providing the decryption key so that it could later be used by the second network device. Similarly, in some embodiments, the tunnel initiation system can provide a second one-time URL, which can be used by the second network device for retrieving information received by a secure tunnel system.

In block 640, information that is to be communicated to the secure tunnel system is identified. Thereafter, such as depicted in block 650, the information is enabled to be encrypted, such as by using the encryption key. In block 660, the now encrypted information is enabled to be sent to the secure tunnel system via the Internet, such as by using the one-time URL.

Reference will now be made to the flowchart of FIG. 7, which depicts representative functionality of an embodiment of the tunnel completion system 520. As shown in FIG. 7, the tunnel completion system or method 520 may be construed as beginning at block 710, where information corresponding to the user's intent to provide the second network device with information is received. In some embodiments, this information can be in the form of a one-time URL that is configured to permit retrieval of information via the Internet. In block 720, information corresponding to a decryption key that is to be used for decrypting retrieved information is received. In block 630, retrieval of the encrypted information is enabled. Thereafter, such as depicted in block 640, the retrieved encrypted information is enabled to be decrypted using the decryption key. In some embodiments, such as when the second network device is, or is associated with, a printing device, the additional function of enabling the decrypted information to be printed is included.

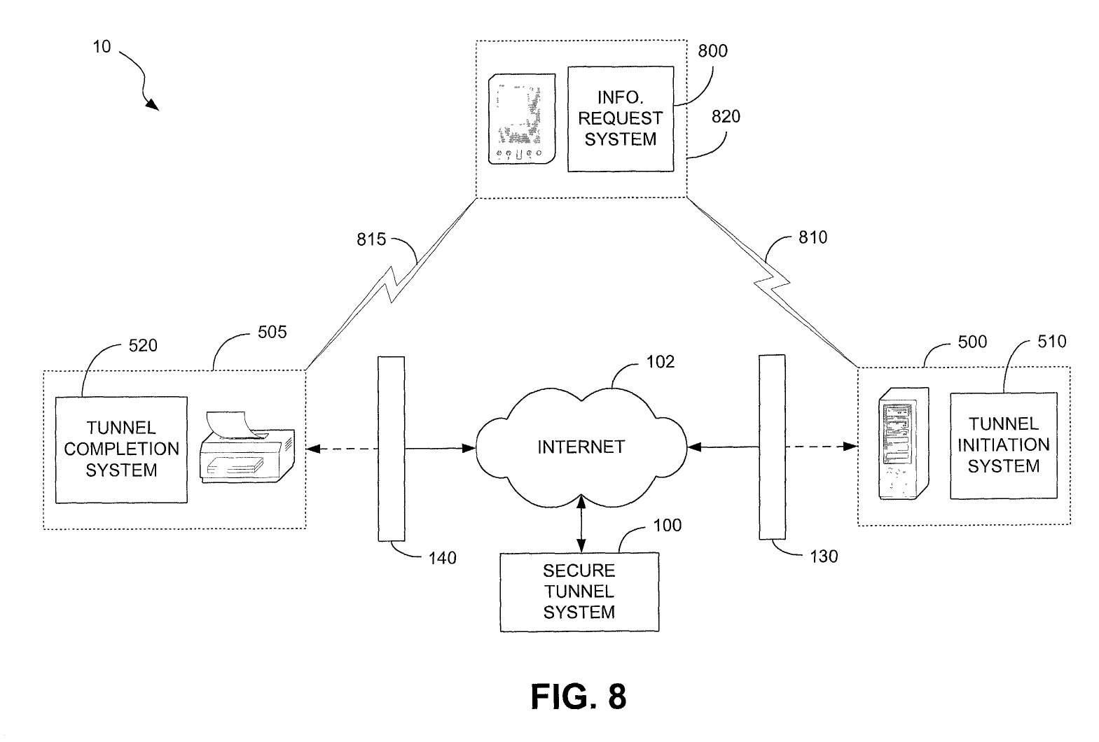

Another embodiment of a secure communication system 10 is depicted in the schematic diagram of FIG. 8. As shown in FIG. 8, an information request system 800 is provided that is configured to communicate with the first and/or second network devices via communication links 810 and/or 815 respectively. The communication links can be facilitated by any type of communication network employing any network topology, transmission medium, or network protocol. For example, the network(s) may be any public or private packet-switched or other data network, including circuit-switched networks, such as the public switched telephone network (PSTN), wireless network, or any other desired communications infrastructure and/or combination of infrastructures. Typically, however, the network(s) used to establish the communication link(s) operates at a lower bandwidth than the Internet and, preferably, facilitates communication with the network device(s) via a wireless protocol, such as Bluetooth or irDA standards, for example. Although the network(s) may operate at a lower bandwidth than the Internet, the network(s) potentially offers a correspondingly higher degree of information security than that typically provided by the Internet. Therefore, use of such a network can be advantageously used for facilitating certain security aspects of an intended information transfer from a network device over the Internet. For instance, such a network can communicate the user's intent to use a secure tunnel service to the first network device. Additionally, the network(s) can be used to provide a one-time URL and a decryption key to the second network device.

Preferably, the information request system is associated with a mobile appliance 820, such as a personal digital assistant or mobile phone. Such a mobile appliance can be configured to perform various functions, at least some of which facilitate functionality of the secure communication system 10.

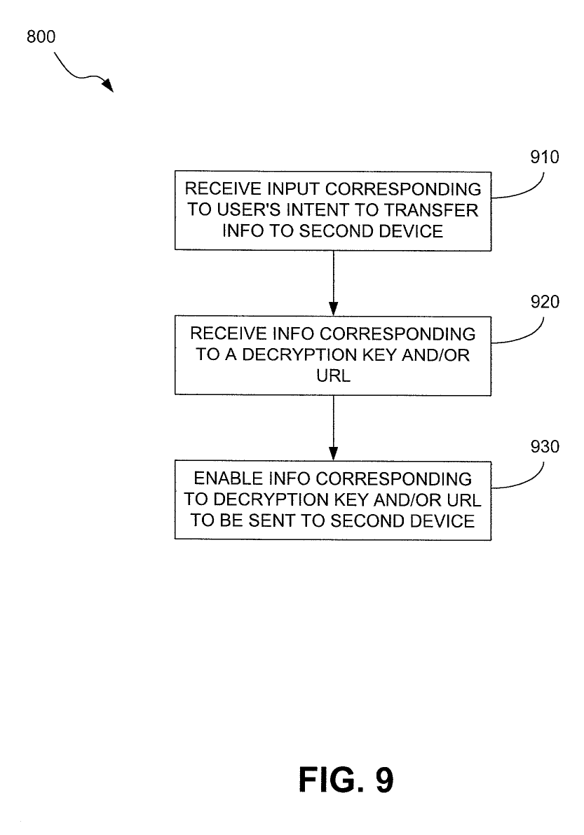

Functionality of an embodiment of an information request system will now be described with reference to the flowchart of FIG. 9. As shown in FIG. 9, the information request system or method 800 may be construed as beginning at block 910, where information corresponding to the user's intent to transfer information from the first network device to a second network device is enabled to be provided. By way of example, the information request system could receive an input from the user and then transmit information corresponding to the input to the first network device. In block 920, information corresponding to a decryption key and/or URL is received. Thereafter, such as depicted in block 930, information corresponding to the decryption key and/or URL is enabled to be communicated to the second network device. Preferably, communication of information to and/or from the information request system is facilitated via a wireless communication protocol, such as the Bluetooth specification.

Operation of a representative embodiment of the secure communication system 10 will now be described with reference to the schematic diagram of FIG. 8. For ease of description, several assumptions will be made. For example, it is assumed that the user intends to transfer information from the first network device, which can be a content server, to a second network device, which is, or is associated with, a printing device. Thus, the user intends to transfer information to the second network device so that the information can be printed.

A user can initiate a transfer of information using a mobile appliance. In particular, the user can request initiation of the secure tunnel service by actuating a print actuator, e.g., a button or icon, of the mobile appliance. In response to such actuation, the mobile appliance may provide information to a first network device, which is to provide information to a second network device. More specifically, an information request system of the mobile appliance can provide the information to the first network device, which includes or is otherwise associated with a tunnel initiation system. The information provided to the first network device can include one or more of: an identification of information to be transferred, a request for a tunnel URL and/or decryption key, and/or printer configuration information.

As a first example, the mobile appliance could request a tunnel URL and decryption key that are to be used by the second network device. Typically, the tunnel URLs to be used during the transfer of information are requested from the secure tunnel service by the tunnel initiation system. The timing of such a request may vary among embodiments. For instance, in some embodiments, the tunnel initiation system can provide a mobile appliance with encryption/decryption keys and/or one or more URLs prior to receiving information corresponding to a request for using a secure tunnel system. In such an embodiment, this information could be stored by the mobile appliance and/or the tunnel initiation system. In other embodiments, however, the tunnel initiation system can initiate a request for tunnel URLs in response to receiving information from the mobile appliance corresponding to the user's intent to establish a secure tunnel.

Likewise, the tunnel initiation system also can facilitate identification of encryption/decryption keys. For example, the tunnel initiation system can generate the keys in response to receiving information corresponding to the user's intent to initiate a secure tunnel. In such an embodiment, the tunnel initiation system associated with the first network device could then provide a decryption key to the mobile appliance so that the mobile appliance can forward the decryption key to the second network device. In another embodiment, the tunnel initiation system can forward the decryption key to the mobile appliance; however, this could be done prior to receiving information corresponding to the user's intent to establish a secure tunnel. Therefore, in such an embodiment, the mobile appliance stores the decryption key for later use.

As mentioned before, the mobile appliance also can provide printer configuration information to the tunnel initiation system. In particular, this information is intended to permit the first network device to properly configure the information that is to be communicated to the second network device so that the information can be properly printed. However, if it is assumed that the second network device is capable of processing postscript data, the printer configuration information may not be required to be passed to the tunnel initiation system. Note, in some embodiments, the second network device can pass printer configuration information to the first network device via the secure tunnel system. Also note that if the second network device is not a printer, other device-specific information could be passed to the first network device so that information that is intended to be communicated can be properly configured for use by the second network device.

Regardless of the particular technique used for initiating use of a secure tunnel system, once receiving respective URLs, the first and second network devices can establish communication with the secure tunnel system using the URLs. Encrypted information then can be communicated from the first network device and provided to the secure tunnel system, which then posts the encrypted information. Since the secure tunnel system is able to host the information posted at the URL, once the first network device provides the encrypted information to the secure tunnel system, the first network device can disconnect from the secure tunnel system. However, in those embodiments where printer configuration information is to be obtained from the second network device, the first network device typically remains connected until the second network device connects and provides the printer configuration information to the secure tunnel system. Clearly, if the second network device established communication with the secure tunnel system before the first network device, the second network device typically would wait or block until the information that is to be retrieved is posted.

Once the encrypted information is posted, the second network device can retrieve or get the encrypted information. The encrypted information then can be decrypted by the second network device by using the previously received decryption key. The now decrypted information then can be printed. In some embodiments, once the information has been printed, the second network device can return information corresponding to the success of the print operation to the mobile appliance. In response to such information, the mobile appliance could display a message to the user indicating that printing was successful.

It should be noted that various ones of the aforementioned functions can be accomplished simultaneously, or nearly so. For example, if the mobile appliance stores encryption/decryption keys and reference URLs for use by the first and second network devices, and then forwards the appropriate information to each of those devices, both of the network devices can attempt to establish communication with the secure tunnel service substantially simultaneously.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated.

For instance, although the secure tunnel systems and methods of the present invention are described herein in relation to transferring information from devices of separate networks, each of which includes a firewall, the invention can also be used with a device of a network that is not associated with a firewall. Such a device could be deployed to support the secure tunnel service. For example, such a device could be a printer for printing information communicated from a network device via a secure tunnel system. All such modifications and variations, are within the scope of the invention as determined by the appended claims.

1. A method for securely communicating information, said method comprising:
communicating an address to a first network device via the Internet such that the first network device provides information corresponding to the address for use by a second network device;
receiving encrypted information from the first network device via the Internet;
enabling the encrypted information to be posted at the address; and
enabling the second network device to access the address and retrieve the encrypted information posted at the address.

2. The method of claim 1, further comprising:
after the encrypted information has been retrieved by the second network device, preventing the encrypted information from being retrieved from the address again.

3. The method of claim 2, wherein a first firewall is communicatively coupled between the first network device and the Internet.

4. The method of claim 2, wherein the address provided to the first network device is a first Uniform Resource Locator (URL) configured for a one-time use; and
wherein the second network device retrieves the encrypted information using a second URL, the second URL being configured for a one-time use.

5. The method of claim 1, wherein the encrypted information is provided from the first network device to the second network device without either of the first and second network devices being identified to the other.

6. The method of claim 1, wherein the address is provided to the second network device via a mobile appliance, the mobile appliance communicating with the first and second network devices via wireless communication links.

7. The method of claim 1, wherein a decryption key is provided to the second network device via a secure communication protocol, the decryption key being configured to enable decryption of the encrypted information.

8. The method of claim 7, wherein the secure communication protocol uses the Bluetooth specification.

9. The method of claim 7, wherein the decryption key is provided to the second network device via a mobile appliance, the mobile appliance communicating wit h the first and second network devices via wireless communication links.

10. The method of claim 9, wherein the decryption key is generated by the first network device; and
wherein the mobile appliance receives the decryption key from the first network device.

11. The method of claim 1, wherein the second network device is a printing device configured to receive the encrypted information, decrypt the information, and print the information.

12. A system for enabling secure communication of information between a first network device and a second network device via the Internet, said system comprising:
a secure tunnel system communicating with the Internet;
the secure tunnel system being configured to:
provide address information to a first network device via the Internet;
receive encrypted information from the first network device via the Internet, post the encrypted information at an address associated with the address information; and
enable a second network device to access and retrieve the encrypted information from the address via the Internet while the encrypted information is posted.

13. The system of claim 12, wherein the secure tunnel system is configured to prevent the encrypted information from being retrieved again after the encrypted information has been retrieved by the second network device.

14. The system of claim 12, further comprising:
means for preventing the encrypted information from being retrieved again after the encrypted information has been retrieved by the second network device.

15. The system of claim 14, wherein the means for preventing the encrypted information from being retrieved again comprises:
means for generating a Uniform Resource Locator (URL) for use by the second network device, the URL being configured for a one-time use such that, after the second network device uses the URL to retrieve the encrypted information, the URL can no longer be used to retrieve the encrypted information.

16. A method for securely communicating information, said method comprising:
providing a first network device;
receiving, at the first network device, an address via the Internet;
providing a decryption key and the address to a mobile appliance via a secure communication link; and
providing encrypted information to the address via the Internet, such that a second network device is enabled to access and retrieve the encrypted information from the address via the Internet while the encrypted information is posted and decrypt the information using the decryption key provided from the mobile appliance.

17. The method of claim 16, further comprising:
receiving an input from a user, the input corresponding to the user's intent to have information communicated to the second network device;
in response to the user input, establishing communication with a third network device via the Internet, the third network device being configured to provide the first network device with a first Uniform Resource Locator (URL) for use by the first network device and a second URL for use by the second network device, the first URL being configured for a one-time use such that the first network device can post encrypted information at the address using the first URL, the second URL being configured for a one-time use such that the second network device can retrieve the encrypted information from the address using the first URL; and
receiving the first and second URL's from the third network device.

18. The method of claim 16, further comprising:
generating a decryption key for decrypting the encrypted information.

19. A system for enabling secure communication of information between a first network device and a second network device, said system comprising:
an information request system configured to communicate with the first and second network devices,
the information request system being configured to receive an input from a user, the input corresponding to the user's intent to have encrypted information communicated to the second network device,
the information request system being further configured to receive a decryption key and information corresponding to an address from the first network device in a secure format, the information request system providing the decryption key and the information corresponding to the address to the second network device in the secure format, thereby enabling the second network device to access and retrieve encrypted information posted on the Internet at the address and decrypt the information using the decryption key.

20. The system of claim 19, further comprising:
a mobile appliance configured to communicate with the first and second network devices; and
wherein the information request system is a part of the mobile appliance.
